(19) United States
(12) Patent Application Publication
(10) Pub. No.: US 2024/0308281 A1
(43) Pub. Date: Sep. 19, 2024

(54) GOOSENECK TRAILER HITCH TONGUE AND TRAILER

(71) Applicant: HORIZON TRAILERS LLC, EL PASO, TX (US)

(72) Inventors: BERNHARD LOEWEN NEUFELD, Riva Palacio (MX); ANTONIO MARQUEZ PALACIOS, Riva Palacio (MX); JACOB LOEWEN NEUFELD, Riva Palacio (MX)

(21) Appl. No.: 18/186,145

(22) Filed: Mar. 17, 2023

(51) Int. Cl. B60D 1/167; B60D 1/14

(52) U.S. Cl. CPC B60D 1/167; B60D 1/143

(57) ABSTRACT

A trailer including a trailer frame, a hybrid gooseneck trailer hitch tongue, and a coupling. The tongue may include I-beam stanchions connected to the front of the trailer frame, extending upward and leaning forward, with engineered I-beam necks extending forward from the tops of the stanchions, angling toward each other, and then curving downward and terminating at the coupling. The engineered necks are made from two plates. One plate defines forward and middle neck portions, and the other plate defines a roughly triangular rear neck portion. The roughly triangular plate is non-coplanar with the other neck plate and with the web of the stanchion. Lower and upper flanges are attached or welded to the lower and upper edges of the plates, thus defining a gooseneck profile. The lower flange profile may have four approximately linear sections smoothly joined by three curved sections.

### REFERENCE TO RELATED APPLICATIONS

Reference is made to a U.S. design patent application with the title, “Gooseneck Trailer Hitch Tongue,” by the same inventors, filed the same day as this application, the entire contents of which are hereby incorporated herein by reference.

### BACKGROUND OF THE INVENTION

This invention relates generally to a gooseneck trailer, more particularly to the tongue portion of a gooseneck trailer hitch.

The trailer tongue is a structure extending forward from the front of a trailer or trailer frame and terminating at a hitch or coupling that mates with a complementary hitch or coupling located on a truck or tractor vehicle for pulling the trailer. A “gooseneck” or “fifth wheel” trailer is meant to be attached to a hitch point over the center of the rear axle of a truck. This location allows for greater tongue weight and sharper turns than a bumper-hitch located at the rear of the vehicle. The most common gooseneck hitch location is in the center of the bed of a pickup truck, thus requiring the traditional gooseneck shape for the tongue to extend upward from the trailer front, over the rear end of the truck, and down into the truck bed. Sometimes the “fifth wheel” hitch is differentiated from the “gooseneck” hitch by the use of a kingpin connection in the former and a ball-hitch in the latter. The term “gooseneck” will be used herein for the trailer tongue regardless of the type of coupling.

US2018/126809A1 includes a drawing of a traditional gooseneck tongue design. FIG. 1A and FIG. 1B are a side view and top view, respectively, of a trailer with a conventional gooseneck tongue constructed from standard I-beams. These drawings serve to illustrate the general shape and parts of a conventional gooseneck tongue. In FIGS. 1A and 1B, trailer 10 includes trailer frame 12 and conventional gooseneck hitch with tongue 14. Tongue 14 includes two parallel vertical stanchions 15a, 15b spaced apart and extending upright from the front of the trailer frame 12. Extending forward from the top of the two stanchions are two neck members angled toward each other and terminating at coupler 18. Each of the neck members include a rear neck member 16a, 16b and a forward neck member 17a, 17b. Rear neck members 16a, 16b are generally horizontal, while forward neck members 17a, 17b are generally angled downward toward the coupling 18 to which they are attached. Each of the neck members and the upright are typically formed from off-the-shelf, standard steel beams such as I-beams, channel or C-beams, or the like, all welded together. The neck is thus limited in design to straight sections. The two neck members and/or the two stanchions may be connected by one or more transverse members such as transverse beam 19. Also, there are often additional braces welded on such as triangular plate 13 to reinforce the I-beam structure. The sharp corners where the I-beams are joined are reported to be stress points. The structure is also relatively heavy. Standard I-beams are also called rolled I-beams, and may be cold rolled, hot rolled, or extruded.

U.S. Pat. Pub. No. 2022/0153071 A1, U.S. Design Pat. No. 941711 S and U.S. Design Pat. No. 838211 S disclose a second type of gooseneck tongue design based on so-called “engineered” beams. FIG. 2 is a perspective view of a representative trailer 20 with an engineered gooseneck tongue 24. In FIG. 2, trailer 20 includes trailer frame 12 and engineered gooseneck tongue 24. Tongue 24 includes two parallel vertical portions 25a, 25b extending upright from the front of the trailer frame 12. Extending forward from the top of the two vertical portions are two neck portions 21a, 21b angled toward each other and terminating at coupler 18. Each of the neck members 21a, 21b include a rear neck member 26 and a forward neck member 27. Each of the neck portions and the vertical portion are typically formed from a single steel plate cut into the gooseneck shape as shown. The upper edge of the plate is lined with upper flange 23a, while the lower edge of the plate is lined with lower flange 22a, thus resulting in the engineered I-beam for the gooseneck. The plate includes vertical crease 29 to permit the neck members 21a. 21b to angle toward the coupling 18. The engineered beam may be lighter and may allow for more choices of design shape than the conventional I-beam structure of FIGS. 1A and 1B, but it is also generally more expensive and may not be as stiff. The two neck portions and/or the two vertical portions may also be connected by one or more transverse members such as transverse beam 19 to stiffen the structure. Engineered beams may also be called plate girders, plate beams, or welded beams, and are made by welding plates together.

What is needed is a gooseneck trailer tongue with flexibility of design shape, good stiffness and strength, and economical.

### SUMMARY OF THE INVENTION

The present invention is directed to systems and methods which provide for a trailer with an improved gooseneck tongue, in particular a hybrid gooseneck tongue with both an engineered I-beam portion and a standard I-beam portion.

In one general aspect, a gooseneck trailer may include a trailer frame, a hybrid gooseneck trailer hitch tongue, and a coupling. The tongue is connected to the front of the trailer frame, extending upward and forward therefrom and terminating at the coupling. The hybrid tongue includes at least one standard I-beam component and at least one engineered I-beam component. Preferably the standard I-beam components are the stanchions which are attached to the front of the trailer's frame and extend upward. Preferably the stanchions are angled or leaning forward at a predetermined angle greater than zero degrees. Preferably the engineered I-beam components are the two necks that are attached to the front of the stanchions and extend forward angled toward each other and terminating at the coupling.

The engineered I-beams forming the necks neck may include two plates mitered together. The first plate defines the forward neck portion and the middle neck portion and may be oriented vertically. The second plate defines a roughly triangular rear neck portion with a first straight edge connected and mated to the rear edge of the first plate and defining a first seam. These two plates are non-coplanar and non-parallel, meeting at a predetermined angle. The second plate has a second straight edge connected to one of the stanchions defining a second seam. The second plate and the stanchion web are also non-coplanar and non-parallel. The second plate includes a third edge that is curved forming part of the gooseneck profile. The lower edge of the vertical plate and the curved third edge of the rear neck portion have a lower flange welded or otherwise attached thereon, and the upper edge of the plate has an upper flange welded or otherwise attached thereon. The lower flange of the neck may define a profile having four substantially straight portions smoothly connected by three curved portions.

The invention is directed to the hybrid tongue itself and to a trailer incorporating the tongue. Any type of hitch or coupling may be used with the inventive gooseneck tongue described herein. Likewise, all kinds of trailers, including without limit, closed, flat bed, or open trailers, may utilize the inventive gooseneck tongue described herein.

The foregoing has outlined rather broadly the features and technical advantages of the present invention in order that the detailed description of the invention that follows may be better understood. Additional features and advantages of the invention described herein form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1A is a partially fragmented side view of a prior art gooseneck trailer;

FIG. 1B is a partially fragmented top view of the prior art gooseneck trailer of FIG. 1A;

FIG. 2 is a partially fragmented perspective view of another prior art gooseneck trailer;

FIG. 3 is a perspective view of a gooseneck trailer according to an embodiment of the invention;

FIG. 4 is a perspective view of a gooseneck trailer hitch tongue according to an embodiment of the invention;

FIG. 5 is a side elevation view of the gooseneck tongue embodiment of FIG. 4;

FIG. 6 is a sectional view at line 6-6 of FIG. 5; and

FIG. 7 is a partially fragmented sectional view at line 7-7 of FIG. 5.

### DETAILED DESCRIPTION

The invention is a hybrid gooseneck trailer tongue and a trailer using it. “Hybrid” means it draws on two types of fabrication components, standard I-beam components and engineered beam components.

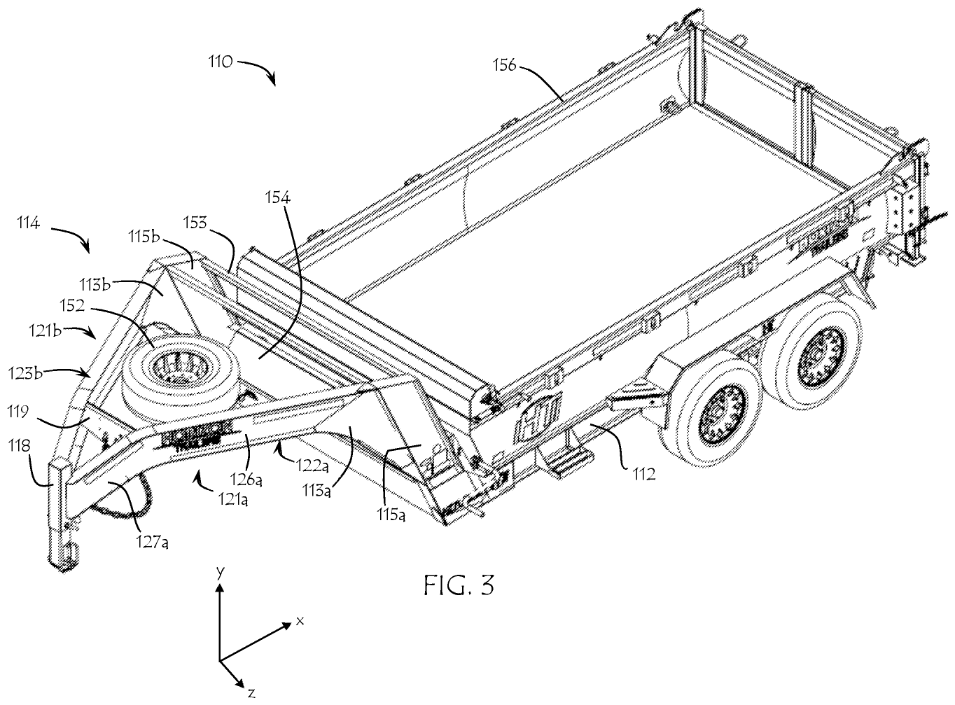

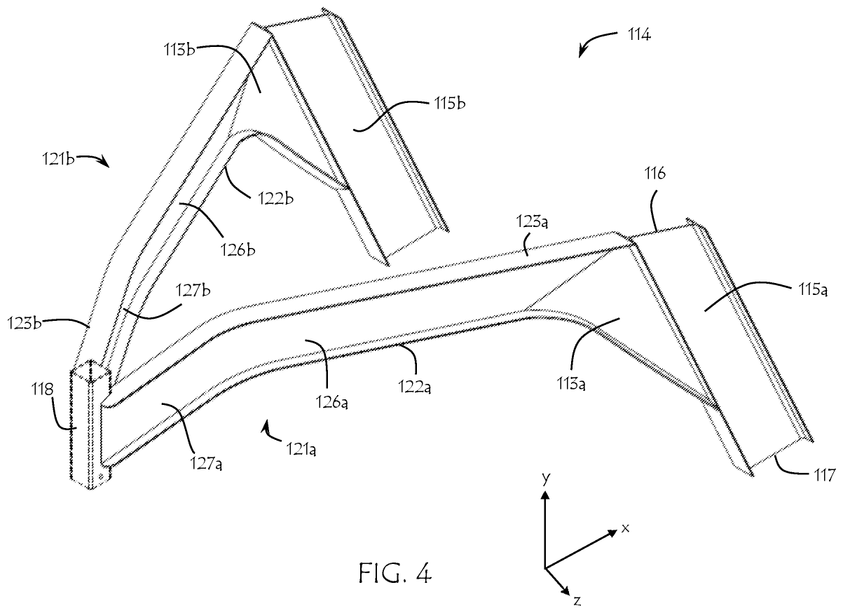

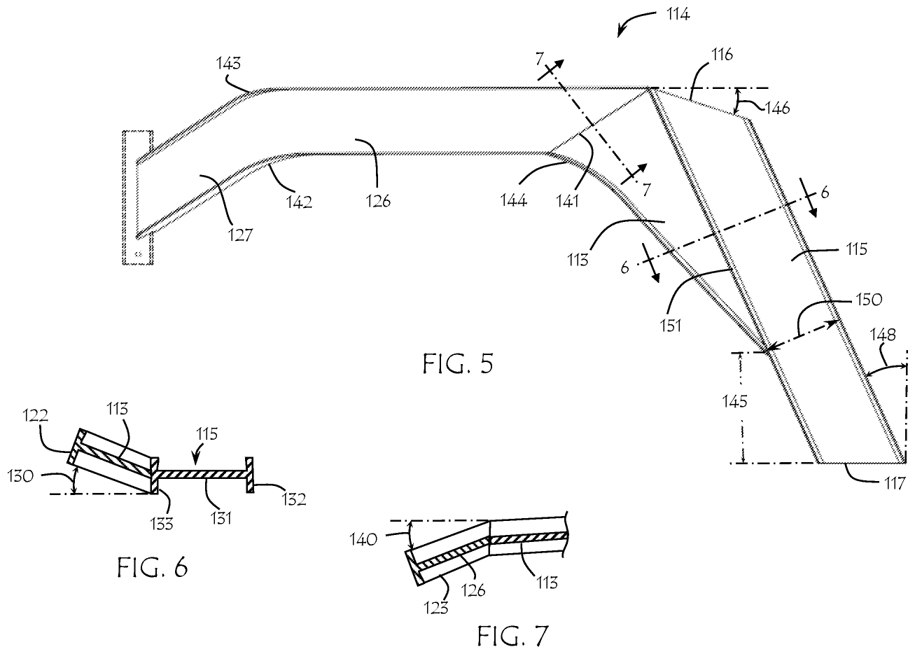

FIG. 3 illustrates a gooseneck trailer with a hybrid gooseneck tongue according to an embodiment of the invention. FIGS. 4-7 illustrate the hybrid gooseneck tongue according to an embodiment of the invention. FIGS. 3 and 4 are perspective views, FIG. 5 is a side elevation view, and FIGS. 6 and 7 are sectional views to show specific details of the embodiment. In FIG. 3, gooseneck trailer 110 includes trailer frame 112 and hybrid gooseneck tongue 114 connected to or mounted on the front of trailer frame 112. Gooseneck tongue 114 includes angled I-beam stanchions 115a and 115b and engineered necks 121a and 121b. The engineered necks 121a, 121b include respective forward neck portions 127a, 127b, middle neck portions 126a, 127b, which are formed from a first plate, and roughly triangular rear neck portions 113a, 113b formed from a second plate. The engineered necks 121a, 121b include lower flanges 122a, 122b attached to the lower edges of the two plates, and upper flanges 123a, 123b attached to the upper edge of the first plate, thus making the necks engineered I-beams. The engineered necks 121a, 121b, are attached to the front of the stanchions and angle toward each other and meet the coupling 118 at the forward most end of the tongue 114. Additional braces such as transverse brace 119 between the necks 121a and 121b, a brace to support spare tire 152, and transverse brace 153 between stanchions 115a and 115b are optional. Toolbox 154 mounted on frame 112 between the stanchions 115a and 115b is also optional.

For convenience, the horizontal direction in FIGS. 3 and 4 will be called the “x-direction,” and the vertical direction in FIGS. 3 and 4 will be called the “y-direction.” The “z-direction” would be another horizontal direction perpendicular to the x-direction in FIGS. 3 and 4. Accordingly, in FIG. 5, a horizontal axis is the x-direction, the vertical axis is the y-direction, and the z-direction is out of the paper. This convention, though arbitrary, will permit a discussion of the orientation of the components of the hybrid gooseneck tongue. FIG. 6 includes a section of the I-beam forming stanchion 115. When describing an I-beam such as stanchion 115, the top and bottom transverse members of the “I” 132 and 133 will be called “flanges,” and the central connecting portion will be called the web 131. Likewise, for the engineered I-beam forming necks 121a and 121b, the transverse members will be called the top and bottom “flanges,” or equivalently, upper flanges 123a and 123b and lower flanges 122a and 122b. The vertical connecting portions 126 and 127 are again called the “web.” All of these may be of steel and welded together to form a unit. Alternately, the flanges may be attached to the web of the engineered I-beam by any method known to attach the materials used, such as welding, brazing, gluing, riveting, or even forming as one part. For steel, welding is a preferred means of attaching the flanges to the web, and the various plates together and to the I-beam, to the coupling, and to the various optional components.

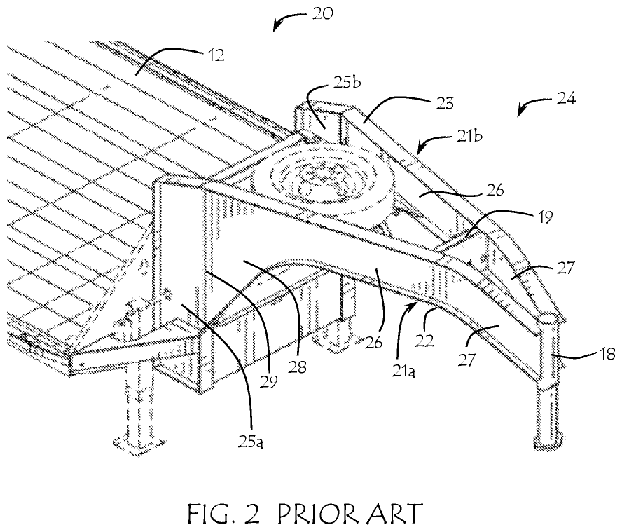

The primary inventive aspect of the trailer is the hybrid gooseneck tongue of the hitch system. The tongue is a hybrid construction including both off-the-shelf or standard I-beam components and engineered I-beam components. The hybrid design is advantageously able to be optimized for weight, strength, cost, beauty, and ease of manufacture. Where maximum strength and rigidity is needed in straight sections, namely in the stanchions 115, the standard I-beam is well-suited. In the forward and middle portions of the neck, where curved shapes are advantageous and aesthetically desirable, the engineered I-beam portions are well-suited. Compared to the prior art engineered design of FIG. 2, the inventive gooseneck has an additional flange where the neck is attached to the stanchion. This helps stiffen the stanchion. In addition, the use of the roughly triangular rear neck portions 113a, 113b results in additional reinforcement to the whole tongue as will be explained further below. As shown in the figures, “roughly triangular” means a 3-sided shape with two straight edges or sides and a third edge that is curved.

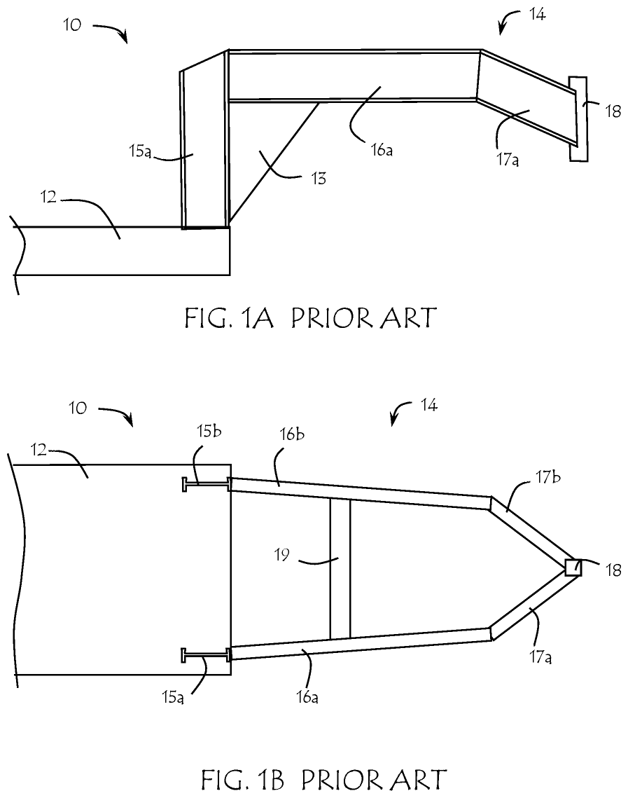

Preferred embodiments of the invention may include several additional design features which may be best described by referring to FIGS. 5-7. The first such feature is the angle 148 of stanchions 115 with respect to the vertical or y-axis. Prior art designs such as shown in FIGS. 1 and 2 all have vertical stanchions. The inventors have discovered that an angled stanchion advantageously provides some additional space to accommodate trailer box 156, while maintaining sufficient strength, and also gives the tongue a more sleek and stylish appearance. Thus, the stanchions may be set at a stanchion angle preferably greater than 0° up to about 30° forward from vertical. In preferred embodiments the stanchion may be leaned forward with a predetermined stanchion angle 148 in the range from about 20° to 30°, or from 23° to 27°, or from 24° to 25° or 26°.

Along with the stanchion being angled forward, the stanchion top edge 116 and the stanchion bottom edge 117 may be cut at a desired angle. For example, bottom edge 117 may be cut along the x-axis for aesthetic alignment with trailer frame 112, or for other purposes. Top edge 116 may preferably be cut at an angle 146 in the range of from 0° to about 45°, or from about 10° to about 30°, or from about 15° to about 20°. In addition to enhancing the sleek appearance of the gooseneck, this reduces weight without sacrificing strength.

The web of each stanchion 115 is preferably in the x-y plane, i.e., parallel to the x-axis and the y-axis. The middle neck portion 126 and the forward neck portion 127 preferably have a web formed from a single steel plate with the web oriented vertically, i.e., parallel to the y-axis, but at an angle to the x-axis in order to connect between a stanchion 115 and the coupling 118. The choice of angle with respect to the x-axis depends on the desired length of the gooseneck and the width of the trailer frame 112 and/or the distance between the two stanchions 115.

Now consider the web of the roughly triangular rear neck portions 113 which are cut from a second plate. The upper edge of the plate or web of rear neck portion 113 is a first straight edge and forms a mitered or miter-style joint 141 with the rear edge of the middle neck portion 126. The rear edge of the web of the rear neck portion 113 is a second straight edge and forms another joint 151 where it is attached to the front flange of the stanchion 115, i.e., to the forward most flange of the stanchion I-beam. Because of the orientation of the middle neck portion 126 and the stanchion 115 with the stanchion leaning forward, the triangular rear neck portion 113 is not parallel to either but forms an angled portion of the neck that stiffens the structure significantly while still providing a continuation of the curved shape of the underside of the gooseneck. In other words, the rear neck portion or second plate is non-coplanar with the first plate of the forward and middle neck portions. It is also non-coplanar with the web of the stanchion. It is therefore not vertical.

FIG. 6 is a sectional view through triangular plate 113 and stanchion 115 perpendicular to the seam or joint 151. Plate angle 130 between plate 113 and stanchion 115 may be predetermined and may preferably be in the range of from about 15° to about 30°, or from 20° to 25°, or about 22.5°. In other words, the triangular plate 113 defines a plane that intersects a plane defined by the web of the stanchion along the line defining the seam 151.

FIG. 7 is a sectional view through triangular plate 113 and the web of middle neck portion 126 perpendicular to the seam or joint 141. Plate angle 140 between plate 113 and neck portion 126 may be predetermined and may preferably be in the range of from about 8° to about 12°, or from 9° to 10°, or about 9.5°. °. In other words, triangular plate 113 defines a plane that intersects a plane defined by the vertical plate of the neck along the line defining the seam 141.

Forward, middle, and rear gooseneck portions also have attractively curved shapes which also minimize stress concentrations in the neck. Upper radius 143, forward lower radius 142, and rear lower radius 144, may be chosen in proportion to the overall size of the hybrid gooseneck tongue and so as to make a smooth and/or continuous profile or gooseneck shape for the neck. For a common and preferred trailer tongue size, radius 142 may be in the range of 20 to 30 inches, radius 143 may be in the range of 15 to 20 inches, and radius 144 may be in the range of from 20 to 30 inches. The upper flange 123a and 123b are attached to the upper edge of the first plate following the upper profile of the neck. The lower flanges 122a and 122b are attached to the lower edge of the first plate and the curved edge of the second plate 113 following the lower profile of the neck. The stanchion I-beam width 150 may be chosen according to the trailer load rating. The starting height 145 of the triangular plate 113 above the base of the stanchion may be chosen to minimize the abruptness of the transition from the stanchion to the neck.

Thus, by choosing appropriate angles, radii, and web dimensions, preferably in the above ranges, it is possible to scale the hybrid gooseneck tongue to fit any desired trailer size or combination of tractor type or truck size and trailer size, while maintaining its strength and beauty of shape.

Now consider a summary of the differences of the hybrid neck from the two types of prior art described in the background section. The stanchions are preferably angled I-beams instead of vertical I-beams and instead of engineered vertical portions having to have a vertical crease in the web. The engineered neck beam uses two shaped plates in the web instead of one and instead of another straight I-beam. The triangular rear neck plate is angled with respect to the forward and middle neck plate and angled with respect to the stanchion, while the prior art only has vertical bracing or vertical webs. Finally, the lower profile or under-side profile of the neck has four substantially straight or linear sections with three curved or smooth transitions between straight sections, while the prior art of FIG. 1A has no such curvature and the prior art of FIG. 2 only has two curved transitions plus an abrupt transition. The inventive profile is thus more shapely and lacks abrupt transitions that may cause stress concentrations.

As a result, this hybrid gooseneck design combines strength, stiffness, and gracefulness while being readily manufacturable by welding steel components and being easily scalable for different trailer applications.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A gooseneck trailer comprising: a trailer frame, a hybrid gooseneck trailer hitch tongue, and a coupling; wherein the hybrid tongue is connected to the front of the trailer frame, extending upward from the trailer frame, then forward therefrom, and terminating at the coupling.

2. The gooseneck trailer of claim 1 wherein the hybrid tongue comprises at least one standard I-beam component and at least one engineered I-beam component.

3. The gooseneck trailer of claim 1 wherein the tongue comprises a stanchion extending upward from the front of the trailer frame, and wherein the stanchion comprises a standard I-beam formed with a web and two flanges.

4. The gooseneck trailer of claim 3 wherein the tongue comprises a neck extending forward from the stanchion and terminating at the coupling; wherein the neck comprises an engineered I-beam.

5. The gooseneck trailer of claim 1 wherein the tongue comprises two parallel and spaced apart stanchions extending upward from the front of the trailer frame and leaning forward at a predetermined stanchion angle, and wherein the stanchions each comprise a standard I-beam formed with a web and two flanges.

6. The gooseneck trailer of claim 5 wherein the tongue comprises two necks, each extending forward from one of the stanchions, angled toward each other, and both terminating at the coupling.

7. The gooseneck trailer of claim 6 wherein each neck comprises an engineered I-beam comprising: a first plate and a second plate mitered together at a predetermined first plate angle; the first plate defining a forward neck portion and a middle neck portion and making up a vertical web portion of the engineered I-beam; and the second plate defining a roughly triangular rear neck portion non-coplanar with the first plate.

8. The gooseneck trailer of claim 7 wherein the second plate comprises two straight edges and one curved edge; the first straight edge connected to a mating rear edge of the first plate to form a first plate angle; the second straight edge connected to its associated stanchion at a second predetermined plate angle so that the second plate and the web of the stanchion are non-coplanar; and the curved edge aligning with a lower edge of the first plate to form a continuous gooseneck profile.

9. The gooseneck trailer of claim 8 wherein the engineered I-beam further comprises: an upper flange connected to an upper edge of the first plate; and a lower flange connected to a lower edge of the first plate and the curved edge of the second plate, thus following the continuous gooseneck profile.

10. The gooseneck trailer of claim 7 wherein the roughly triangular rear neck portion has a first straight edge welded to the first plate and defining a first seam, and a second straight edge welded to one flange of one of the stanchions and defining a second seam.

11. The gooseneck trailer of claim 10 wherein the first plate defines a first plane, the rear neck portion defines a second plane, and the first plane and the second plane intersect at the first seam at a predetermined first seam angle.

12. The gooseneck trailer of claim 11 wherein the web of the associated stanchion defines a third plane, and the third plane and the second plane intersect at the second seam at a predetermined second seam angle.

13. The gooseneck trailer of claim 12 wherein the rear neck portion comprises a third edge that is curved.

14. The gooseneck trailer of claim 13 wherein a lower edge of the first plate and the curved third edge of the rear neck portion have a lower flange attached thereon; and an upper edge of the vertical web has an upper flange attached thereon.

15. The gooseneck trailer of claim 14 wherein the lower flange of the neck defines a profile comprising four substantially linear portions smoothly connected by three curved portions.

16. A hybrid gooseneck trailer hitch tongue comprising: a pair of stanchions formed from standard I-beams; and a pair of necks formed from engineered I-beams.

17. The hybrid gooseneck trailer hitch tongue of claim 16 wherein the stanchions are parallel and spaced apart and are adapted to extend upward and lean forward from the front of a trailer frame at a predetermined angle.

18. The hybrid gooseneck trailer hitch tongue of claim 17 wherein the predetermined angle is greater than zero degrees.

19. The hybrid gooseneck trailer hitch tongue of claim 17 wherein the predetermined angle is in the range from 20° to 30°.

20. The hybrid gooseneck trailer hitch tongue of claim 17 wherein the necks each comprise two plates, a first plate vertically oriented and forming a forward portion and a middle portion of the neck, and a second plate forming a rear portion of the neck and filling an angled space between the first plate and the stanchion; wherein the second plate is non-coplanar with both the first plate and the stanchion.
